(19) United States
(12) Patent Application Publication
(10) Pub. No.: US 2021/0180374 A1
(43) Pub. Date: Jun. 17, 2021

(54) DOOR RETENTION DEVICE

(71) Applicants: John P. Malone, Chicago, IL (US); Nicholas Fisher, Chicago, IL (US); Salmon Antonie Nortje, Somerset West (ZA)

(72) Inventors: John P. Malone, Chicago, IL (US); Nicholas Fisher, Chicago, IL (US); Salmon Antonie Nortje, Somerset West (ZA)

(73) Assignee: RIVERWEST IP LLC, Chicago, IL (US)

(21) Appl. No.: 17/119,645

(22) Filed: Dec. 11, 2020

Related U.S. Application Data
(60) Provisional application No. 62/948,108, filed on Dec. 13, 2019.

(51) Int. Cl. E05C 17/50

(52) U.S. Cl. CPC E05C 17/505

(57) ABSTRACT

A door retention device that can maintain a door in an open configuration includes a wall mounting member adapted to be mounted on a wall or other object at a position where the door retention device can engage an open door, a door retaining member comprising an arm and a door engaging member, and a connection mechanism rotatably connecting the door retaining member to the wall mounting member. The door retaining member is rotatable relative to the wall mounting member between a door receiving position where a door can be received without being retained and a door retaining position where the door engaging member can engage the door in a manner that retains the door in an open configuration. The door retention device can be biased towards a door receiving position, latched in a door retaining position, be adjustable, and/or be universally engageable with multiple shaped doorknobs or handles.

### PRIORITY

The present application claims the benefit of domestic priority based on U.S. Provisional Patent Application 62/948,108 filed on Dec. 13, 2019, the entirety of which is incorporated herein by reference.

### BACKGROUND

For as long as there have been walls, there have been doors. For as long as there have been doors, there has been a need to maintain the door in a desired position and/or to protect the door or a nearby wall from damage resulting from opening the door.

Doors are used in all types of facilities and have any number of design configurations. Some doors are free-swinging and some are spring biased towards a closed configuration. With either a free-swinging door or with a biased door, it can sometimes be desirable to maintain the door in an open configuration. The most common way to maintain a door in an open position is with a door holding wedge that is positioned under the door. However, door holding wedges suffer from several disadvantages. For example, a door holding wedge is easy to misplace and is not always easily locatable in a fixed location. This can lead to frustration when a wedge cannot be found. In addition, the process of retaining the door in an open position with a wedge requires some awkward movements such as bending over, pulling the door onto the wedge, and holding the wedge still with a foot. These movements can lead to injuries, especially in the case of workers that have to prop open several doors. Also, if the floor is slick or if the wedge is not sufficiently inserted under the door, the door may not be properly retained. Furthermore, when door retaining wedges are lying around, they can create a tripping hazard and can look untidy.

Another problem that arises with doors is when an object, such as a wall, is within the path of the door's swing arc. For example, sometimes a door will only be able to open about 90 degrees before abutting a wall. Because of this potential abutment, damage can readily occur to the door, wall, and/or doorknob if steps are not taken to prevent the damage. Commonly, a doorstop is installed on the baseboard of the abutting wall or on the door so that the doorstop makes contact with the door and/or wall. However, while these doorstops reduce the damage that occurs, there remains the potential for damage from the part that contacts the doorstop, especially over multiple uses. In addition, when the doorstop is positioned to make contact near the bottom of the door, the bottom force on the door creates an uneven force application to the hinges of the door, and this uneven force can damage the hinges over time.

There is therefore a need for an improved door retention device. There is a further need for a door retention device that can also serve as a door stop. There is a further need for a door retention device that is easily locatable in a known position. There is a further need for a door retention device that is easily operated. There is a further need for a door retention device that is adjustable. There is a further need for a door retention device that is universally applicable to multiple types of doors.

### SUMMARY

The present invention satisfies these needs. In one aspect of the invention, an improved door retention device is disclosed.

In another aspect of the invention, a door retention device can also serve as a door stop.

In another aspect of the invention, a door retention device is easily locatable at a known position and is easily operated to retain a door in an open configuration.

In another aspect of the invention, a door retention device is universally applicable to multiple types of doors, doorknobs, and/or handles.

In another aspect of the invention, a door retention device can be maintained in an upward or door receiving position.

In another aspect of the invention, a door retention device can be latched in a downward or door retaining position.

In another aspect of the invention, a door retention device is automatically locked in a downward or door retaining position when moved into that position.

In another aspect of the invention, a door retention device is latchable in a downward or door retaining position and the latch is releasable by pressing down on the door retention device.

In another aspect of the invention, a door retention device includes an arm that is adjustable.

In another aspect of the invention, a door retention device includes an arm that is adjustable in length and/or in angular orientation.

In another aspect of the invention, a door retention device comprises a door retaining member and a wall mounting member, the door retaining member having a door contacting member that is capable of contacting a door in a manner that selectively maintains the door in an open configuration.

In another aspect of the invention, a door retention device comprises a wall mounting member adapted to be mounted on a wall or other object at a position where the door retention device can engage an open door; a door retaining member comprising an arm and a door engaging member; and a connection mechanism rotatably connecting the door retaining member to the wall mounting member, wherein the door retaining member is rotatable relative to the wall mounting member between a door receiving position where a door can be received without being retained and a door retaining position where the door engaging member can engage the door in a manner that retains the door in an open configuration, and wherein the connection mechanism includes a mechanism that maintains the door retaining member in the door receiving position and that allows selective movement of the door retaining member to the door retaining position.

In another aspect of the invention, a door retention device comprises a wall mounting member adapted to be mounted on a wall or other object at a position where the door retention device can engage an open door; a door retaining member comprising an arm and a door engaging member; and a connection mechanism rotatably connecting the door retaining member to the wall mounting member, wherein the door retaining member is rotatable relative to the wall mounting member between a door receiving position where a door can be received without being retained and a door retaining position where the door engaging member can engage the door in a manner that retains the door in an open configuration, and wherein the connection mechanism includes a latching mechanism that latches the door retaining member to maintain it in the door retaining position.

In another aspect of the invention, a door retention device comprises a wall mounting member adapted to be mounted on a wall or other object at a position where the door retention device can engage an open door; a door retaining member comprising an arm and a door engaging member; and a connection mechanism rotatably connecting the door retaining member to the wall mounting member, wherein the door retaining member is rotatable relative to the wall mounting member between a door receiving position where a door can be received without being retained and a door retaining position where the door engaging member can engage the door in a manner that retains the door in an open configuration, and wherein the arm is adjustable so that the position of the door engaging member relative to the wall mounting member can be adjusted.

In another aspect of the invention, a door retention device comprises a wall mounting member adapted to be mounted on a wall or other object at a position where the door retention device can engage an open door; a door retaining member comprising an arm and a door engaging member; and a connection mechanism rotatably connecting the door retaining member to the wall mounting member, wherein the door retaining member is rotatable relative to the wall mounting member between a door receiving position where a door can be received without being retained and a door retaining position where the door engaging member can engage the door in a manner that retains the door in an open configuration, and wherein the door engaging member comprises a pair of downward extending prongs that define a doorknob shank receiving space whereby the downward extending prongs can engage the backside of a doorknob by receiving a shank of the doorknob in the doorknob shank receiving space.

In another aspect of the invention, a method of maintaining a door in an open configuration comprises providing a door retention device on a wall the door abuts when open, the door retention device comprising a door retaining member having an arm and a door engaging member; maintaining the door retaining member is a door receiving position where the door can be opened and closed; selectively moving the door retaining member out of the door receiving position by overcoming the bias of a spring and into a door retaining position where the door engaging member engages the door in a manner that retains the door in an open configuration.

In another aspect of the invention, a method of maintaining a door in an open configuration comprises providing a door retention device on a wall the door abuts when open, the door retention device comprising a door retaining member having an arm and a door engaging member; maintaining the door retaining member is a door receiving position where the door can be opened and closed; selectively moving the door retaining member out of the door receiving position and into a door retaining position where the door engaging member engages the door in a manner that retains the door in an open configuration and latching the door retaining member in the door retaining position.

In another aspect of the invention, a method of maintaining a door in an open configuration comprises providing a door retention device on a wall the door abuts when open, the door retention device comprising a door retaining member having an arm and a door engaging member; maintaining the door retaining member is a door receiving position where the door can be opened and closed; selectively moving the door retaining member out of the door receiving position and into a door retaining position where the door engaging member engages the door in a manner that retains the door in an open configuration and latching the door retaining member in the door retaining position, and releasing the latch by pressing down on the arm.

In another aspect of the invention, a method of maintaining a door in an open configuration comprises providing a door retention device on a wall the door abuts when open, the door retention device comprising a door retaining member having an arm and a door engaging member; maintaining the door retaining member is a door receiving position where the door can be opened and closed; selectively moving the door retaining member out of the door receiving position and into a door retaining position where the door engaging member engages the door in a manner that retains the door in an open configuration, and adjusting the arm by changing its length and/or angular orientation.

In another aspect of the invention, a method of maintaining a door in an open configuration comprises providing a door retention device on a wall the door abuts when open, the door retention device comprising a door retaining member having an arm and a door engaging member in the form of a hook; maintaining the door retaining member is a door receiving position where the door can be opened and closed; selectively moving the door retaining member out of the door receiving position and into a door retaining position where the door engaging member engages the door in a manner that retains the door in an open configuration.

In another aspect of the invention, a method of maintaining a door in an open configuration comprises providing a door retention device on a wall the door abuts when open, the door retention device comprising a door retaining member having an arm and a door engaging member; maintaining the door retaining member is a door receiving position where the door can be opened and closed; selectively moving the door retaining member out of the door receiving position and into a door retaining position where the door engaging member engages the door in a manner that retains the door in an open configuration; automatically latching the door retaining member in the door retaining position upon movement from the door receiving position to the door retaining position; and releasing the latch to return the door retaining member to the door receiving position to allow the door to be closed.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1A is a schematic perspective view of a version of a door retaining device according to the invention;

FIG. 1B is a schematic side view of the door retaining device of FIG. 1A in a door retaining position;

FIG. 1C is a schematic side view of the door retaining device of FIG. 1A in a door receiving position;

FIG. 2A is a schematic perspective view of the door retaining device of FIG. 1A in use retaining a door with a first type of doorknob;

FIG. 2B is a schematic perspective view of the door retaining device of FIG. 1A in use retaining a door with a second type of doorknob;

FIG. 3 is a schematic perspective view of another version of a door retaining device of the invention;

FIG. 4A is a schematic perspective view of another version of a door retaining device of the invention;

FIG. 4B is a schematic partially sectional perspective view of the door retaining device of FIG. 4A;

FIG. 5A is a schematic perspective view of another version of a door retaining device of the invention;

FIG. 5B is a schematic side view of the door retaining device of FIG. 5A latched in a door retaining position;

FIG. 5C is a schematic side view of the door retaining device of FIG. 5A is an unlatched position;

FIG. 6A is a schematic perspective exploded view of a version of a door retaining device of the invention;

FIG. 6B is a schematic partially sectional side view of the door retaining device of FIG. 6A in a latched door retaining position; and

FIG. 6C is a schematic partially sectional side view of the door retaining device of FIG. 6A in an unlatched position.

### DESCRIPTION

The present invention relates to a door retention device. In particular, the invention relates to a door retention device that can be mounted on a wall or other object to selectively maintain a door in an open configuration. Although the invention is illustrated and described in the context of being useful for retaining a door, the present invention can be used in other ways, as would be readily apparent to those of ordinary skill in the art. Accordingly, the present invention should not be limited just to the examples and embodiments described herein.

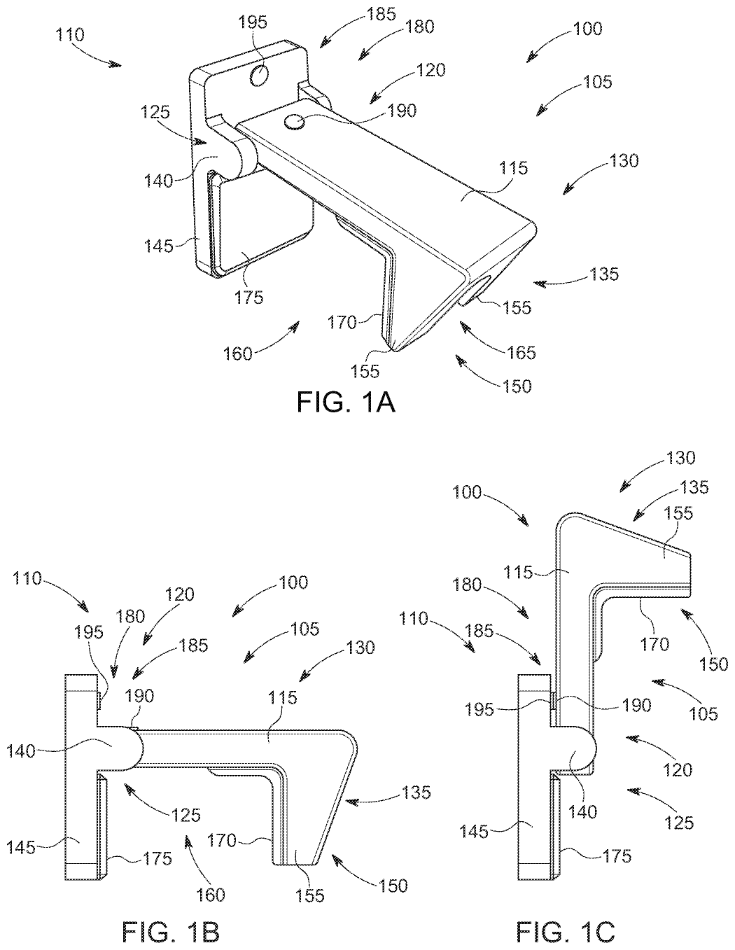

FIG. 1A shows a version of a door retention device 100 according to the invention.

The door retention device 100 includes a door retaining member 105 and a wall mounting member 110. The door retaining member 105 includes an arm 115 having a first end 120. At the first end 120 is a connection mechanism 125 that allows the door retaining member 105 to be connected to the wall mounting member 110. The arm 115 connects to the connection mechanism 125 at the first end and extends to a second end 130 having a door engaging member 135 that is capable of contacting or otherwise engaging a door in a manner that selectively maintains the door in an open configuration. In the version of FIG. 1A, the door retaining member 105 is pivotally or rotationally connected to the wall mounting member 110 by a hinge mechanism 140 that allows the door retaining member 105 to rotate up and down relative to the wall mounting member 110. The wall mounting member 110 includes a wall mounting structure 145, such as a plate or the like, that allows the wall mounting member 110 to be mounted to a wall. The mounting of the wall mounting structure 145 to the wall may be performed in any conventional manner, such as by screws, anchors, or the like.

The rotational motion of the door retaining member 105 relative to the wall mounting member 110 is shown in FIGS. 1B and 1C. In FIG. 1B, the door retention device 100 is shown in a door retaining position. In this position, the door engaging member 135 can contact a door in a manner that holds the door open. The door retaining member 105 is rotatable relative to the wall mounting member 110 by the hinge mechanism 140 to the door receiving position shown in FIG. 1C. In the door receiving position, the door retention device 100 is configured to allow the door to be closed. In the door receiving position, the door retaining member 105 is rotated about a rotational axis of the hinge mechanism 140 upward so the door engaging member 135 does not contact the door in a manner that maintains the door open.

In one version, the door engaging member 135 comprises a hook 150 that extends downwardly from the second end 130 of the arm 115 of the door retaining member 105. The hook 150 can be sized and shaped to latch onto a portion of a door that is to be retained open. For example, in one particular version, the hook 150 can be designed to latch onto a doorknob or handle of the door or other portion of the door. The hook 150 may comprise one or more prongs 155 that project downwardly from the arm 115 when the door retention device is in a door retaining position and are adapted to contact a portion of the doorknob. The one or more prongs 155, the arm 115, and the wall and/or wall mounting member 110 form a knob receiving cavity 160 when the door retention device 100 is in the door retaining position. The knob receiving cavity 160 is sized and shaped to receive the at least a portion of the knob of a doorknob in a manner in which the one or more prongs 155 can engage the doorknob or other portion of the door to maintain the knob in the knob receiving cavity 160. In the version of FIG. 1A, the hook 150 can be made up of two prongs 155 separated by a shank receiving space 165. The shank receiving space 165 can be designed to receive the shank or neck of the doorknob. By shank or neck it is meant any portion of the doorknob between the knob and the door having a cross-sectional dimension smaller than a cross-sectional dimension of the knob. Thus, when a doorknob is received within the knob receiving cavity 160, the shank or neck of the doorknob can be received within the shank receiving space 165, and the prongs 155 can contact the backside of the knob to retain the door. As can be seen, the arm 115 can be shaped to be generally planar and the one or more prongs 155 can extended downwardly from the plane when the arm is in the lowered position. The extension can be at substantially right angles to the plane of the arm or can be angled relative thereto.

In operation, the door retention device 100 is mounted to a wall by the wall mounting member 110 at a height and location where it can engage a doorknob of a door when the door is open. The door retaining member 105 is rotated to the door receiving position as shown in FIG. 1C, and the doorknob is brought into proximity of the door retention device 100. The door retaining member 105 is then rotated to the door retaining position of FIG. 1B so that the doorknob of the door is received within the knob receiving cavity 160 and so that the prongs 155 engage the back of the knob in a manner where they keep the doorknob and door from moving towards a closed configuration. The door retention device 100 can be maintained in the door retaining position with the knob received therein by gravity and/or the pressure of the knob on the prongs 155. To close the door, the door retaining member 105 is rotated upwardly so that the doorknob of the door can move past the prongs 155 and the door can close. The door retention device 100 may optionally have a hook pad 170 and/or a wall mounting member pad 175 made of soft or cushioning material to help prevent damage to the doorknob or other parts of the door.

In one version, the door retention device 100 can also operate as a door stop that prevents damage to the wall from the doorknob or other portion of the door hitting the wall when the door is swung open. For example, the door retention device 100 can be positioned on a wall that would otherwise be contacted by the doorknob or other portion of a door when the door is fully opened at a location where the doorknob or other portion of the door will contact the door retention device 100 instead of the wall. In one version, the door retention device 100 includes a receiving position retaining mechanism 180 that maintains the door retention device 100 in the door receiving position as shown in FIG. 1C. In the door receiving position, the wall mounting member pad 175 can serve as a doorknob contact portion so that when the door swings open, the doorknob or other portion of the door contacts the wall mounting member pad 175 of the door retention device 100. Alternatively or additionally, a pad or other contacting surface may be provided on the exterior of the door engaging member 135 so that the doorknob or other portion of the door contacts the door engaging member 135 when in the down position.

The door retention device 100 may be composed of any suitable material. For example, the door retaining member 105 and/or the wall mounting member 110 may be made of one or more of plastic, such as acrylonitrile butadiene styrene (ABS), polycarbonate, nylon, and the like, metal, such as aluminum, stainless steel, bronze, copper, bronze/copper alloys, carbon steel, tool steels, titanium, cobalt, cobalt chrome, and the like, rubber, silicone, glass, ceramic, and the like. The door retaining member 105 and the wall mounting member 110 may be made of the same or different materials. The parts can be made from injection molding, casting, forging, machining, 3D printing, and/or any other suitable manufacturing technique. The hook pad 170 and/or the wall mounting member pad 175 may be made of one or more of rubber, silicone, and similar synthetic materials.

A particular version of the door retention device 100 shown in FIGS. 1A through 1C, the receiving position retaining mechanism 180 comprises a magnetic system 185. For example, the magnetic system 185 comprises a first magnet 190 on the door retaining member 105 and a second magnet 195 on the wall mounting member 110. The first magnet 190 and the second magnet 195 are of respective polarities that they are attracted to one another. Thus, when the door retaining member 105 is rotated upwardly about the hinge mechanism 140 the attraction between the first magnet 190 and the second magnet 195 holds the door retaining member 105 in the up position or the door receiving position as shown in FIG. 1C. A user can apply a separation force sufficient to overcome the attraction between the first magnet 190 and the second magnet 195 to rotate the door retaining member 105 downwardly and into engagement with the doorknob or other portion of the door when desired. In another version, one of the first magnet 190 or second magnet 195 may be replaced with a ferromagnetic material that is attracted to the other magnet. Alternatively, the magnetic system 185 can be replaced by a mechanical system that includes a latch, snap, or other mechanism, such as a hook and loop fastener. Alternatively, the magnetic system 185 can be replaced by a friction system where the friction force required to rotate the door retaining member 105 relative to the wall mounting member 110 exceeds the gravitational force so that the door retaining member 105 can remaining in the door receiving position on its own.

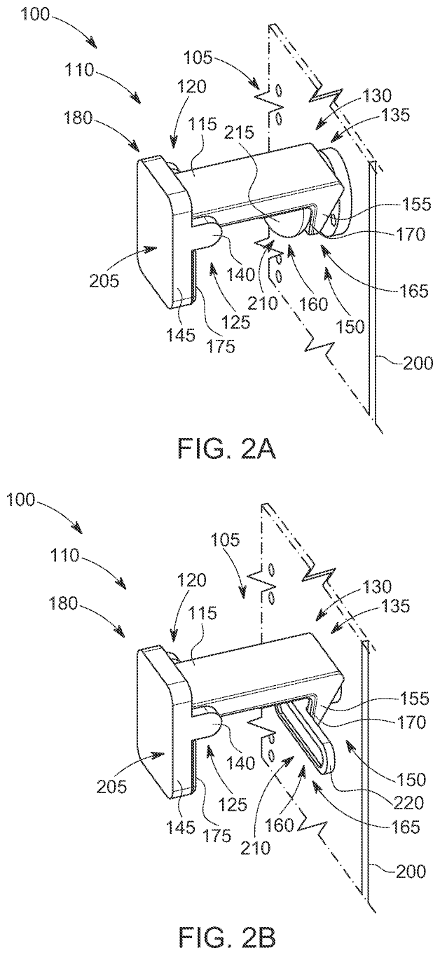

FIGS. 2A and 2B show the door retention device 100 in use retaining a door 200 in an open configuration. The door retention device 100 is mounted onto an abutment wall (not shown for clarity) by securing the back surface 205 of the wall mounting structure 145 to the wall at a position where the door retention device 100 is in alignment with the doorknob 210 of the door 200. In this manner, the door retention device 100 is usable as a door stop, as discussed above. In addition, the door retention device 100 is constantly available in a known location to be used to retain the door 200 without the need to carry and/or search for a door retainer, such as a door retaining wedge. The door retention device 100 also retains the door in a superior manner to a door retaining wedge in that the hook 150 more easily and more securely grasps onto the doorknob 210. Also, as can be seen in FIGS. 2A and 2B, the door retention device 100 can be used with different types of doorknobs 210 making the door retention device universally applicable to multiple shaped doorknobs with shanks. The hook 150 with two prongs 155 can receive the shank of the doorknob within the shank receiving space 165 and the knob or handle of the doorknob can be received within the knob receiving cavity 160. A round doorknob 315 as shown in FIG. 2A or a handled doorknob 220 with a laterally extending handle as shown in FIG. 2B can be used with the door retention device 100. The hook 150 latches around the knob in either configuration. Other doorknob configurations can be used as well provided there is a portion of the doorknob that the hook 150 can latch onto.

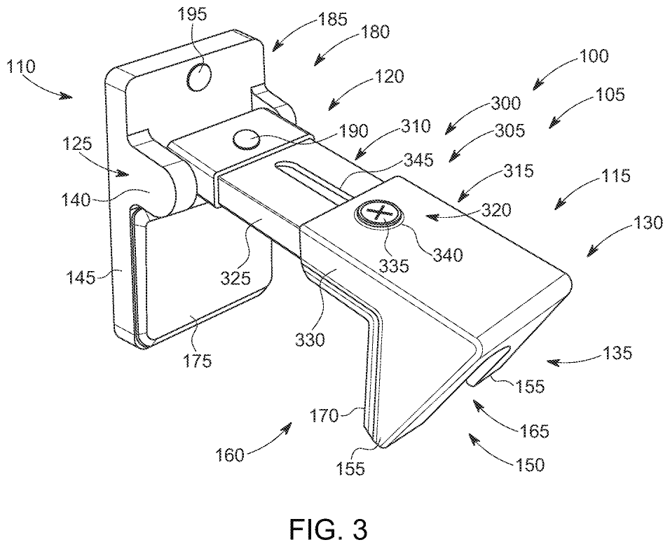

In one version, as shown in FIG. 3A, the door retention device 100 can include an adjustment mechanism 300 that allows the position and/or orientation of the door engaging member 135 to be adjusted relative to the wall mounting member 110 and/or the wall that the door retention device 100 is mounted on. In the version of FIG. 3, the adjustment mechanism comprises a length adjustment mechanism 305 that adjust the length or longitudinal extension of the arm 115 of the door retaining member 105. By adjusting the length of the arm 115, the door retention device 100 can be adapted to be used with different sized and/or shaped doorknobs. Additionally or alternatively, by adjusting the length of the arm 115, the size of the gap between the wall and the retained door can be adjusted. In the version of FIGS. 3, the length adjustment mechanism 305 includes a first arm portion 310 and a second arm portion 315 that is slidable relative to the first arm portion 310. The second arm portion 315 can be locked at a selected position relative to the first arm portion 310 by a locking mechanism 320. In the particular version of FIG. 3, the first arm portion 310 and the second arm portion are telescopically engaging so that the first arm portion 310 comprises a male member 325 that is telescopically received within a female member 330 of the second arm portion 315. Alternatively, the male member can be provided on the second arm portion 315 and the female member can be provided on the first arm portion 310. The locking mechanism 320 can be any mechanism that secures the first arm portion 310 and the second arm portion 315 at a desired position. For example, the locking mechanism 320 can comprise a screw 335 that passes through a hole 340 in the female member 330. The screw 335 also passes through a longitudinally extending slot 345 in the male member 325 and engages threads on the opposite side of the slot 345. The threads can be provided in the opposing side of the female member or in a nut or the like. Alternatively, the screw 335 can be a set screw that has a lower surface that bears on a surface of the male member 325. By female member it is meant any cavity, slot, groove, trough, or the like that can receive the male member in sliding relationship. The female member can surround or partially surround the male member. The length adjustment mechanism 305 of the adjustment mechanism 300 can be designed to make the distance between the wall mounting member 110 or the wall and the hook 150, i.e. the length of the knob receiving cavity 160 a desired amount. In one version, this distance can range from about 0.5 inches to about 12 inches, or from about 1 inch to about 6 inches, or from about 1 inch to about 4.5 inches.

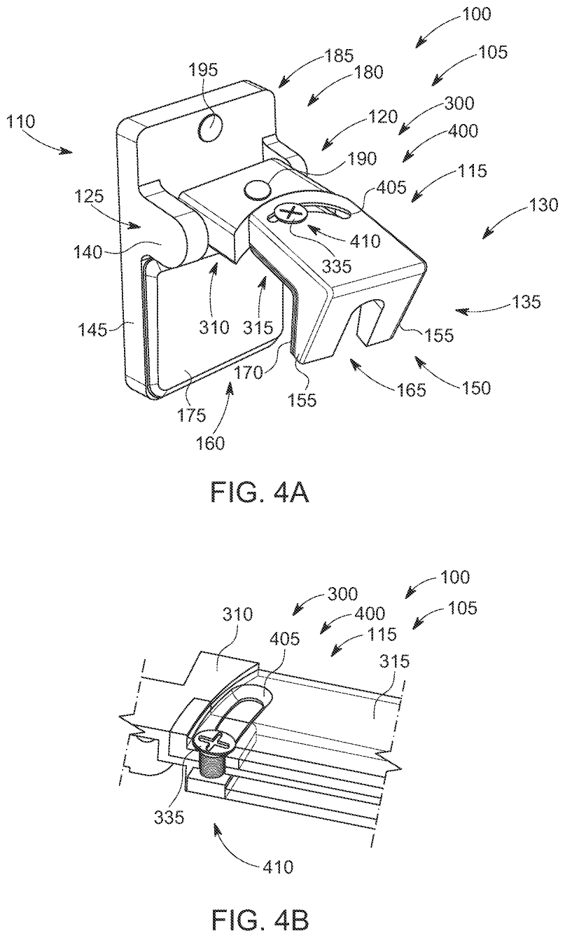

Additionally or alternatively, as shown in FIGS. 4A and 4B, the adjustment mechanism 300 can comprise an angle adjustment mechanism 400. In this version, the angle of second arm portion 315 with respect to the first arm portion 310 can be adjusted. In the version shown in FIG. 4A, the adjusted angle can be an angle lying in the in the generally horizontal plane when the door retention device 100 is in the door retention position. The angle adjustment mechanism 400 allows the angle of the door engaging member 135, and in particular the angle of the hook 150, to be adjusted relative to the wall mounting member 110 and/or the wall the door retention device is mounted to. This allows the door retention device 100 to be more effectively useable in configurations where the door knob and the abutment wall are something other than about 90 degrees. In the version shown, an arcuate slot 405 is provided in the second arm portion 320, or alternatively in the first arm portion 310. A locking member 410, such as a screw 335, which can be received in threads or can be a set screw as discussed above, extends through the arcuate slot 405. When tightened, the screw 335 can secure the second arm portion 315 and to the first arm portion 310 at a desired angular orientation relative to one another. The angle adjustment mechanism 400 of the adjustment mechanism 300 can be designed to make the angle between a central longitudinal axis of the first arm portion 310 and a central longitudinal axis of the second arm portion 315 adjustable relative to one another by an angle of up to about 30 degrees in one or both directions, or up to about 45 degrees in one or more directions. By longitudinal it is meant the general direction from the wall mounting member 110 to the door engaging member 135 when the first arm portion 310 and the second arm portion 315 are aligned.

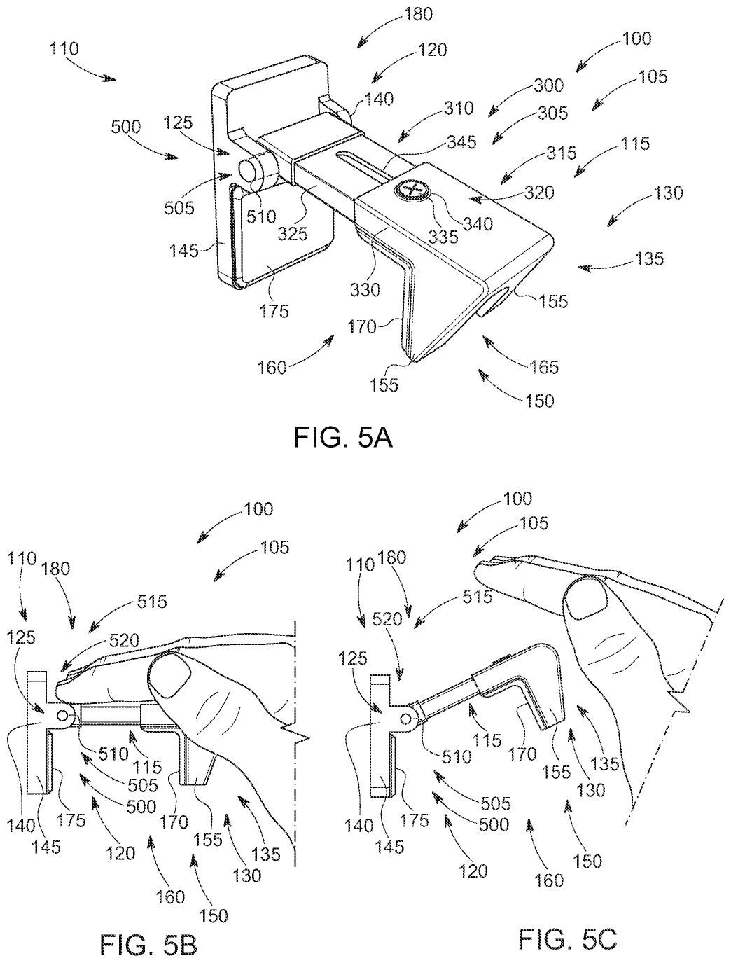

Another version of a door retention device 100 according to the invention is shown in FIG. 5A. In this version, the receiving position retaining mechanism 180 comprises a biasing mechanism 500. For example, the biasing mechanism 500 can comprise one or more springs 505. The biasing mechanism 500 is adapted to bias the door retaining member 105 upwardly toward the wall mounting member 110. Thus, the biasing mechanism 500 biases the door retention device 100 into is door receiving position. To move the door retention device 100 into its door retaining position, sufficient force is applied to the door retaining member to overcome the bias of the biasing mechanism 500 and move the door retaining member 105 into engagement with the doorknob or other portion of the door. The biasing mechanism 500 can comprise one or more torsion springs 510, as shown in the version of FIG. 5A or one or more tension springs, where the one or more tension springs are connected at one end to the door retaining member 105 and at another end to the wall mounting member 110.

For some doors, such as doors that are spring-biased into a closed position, the force of the doorknob on the hook 150 is sufficient to maintain the door retaining member 105 in a downward position. Alternatively, a latching mechanism can be provided to maintain the door retaining member 105 in its downward position. The latching mechanism can include a latch member that is moveable between a latching position that prevents the door retaining member 105 from moving upward and a unlatching position where the door retention member 105 is allowed to move upward in response to the bias of the biasing mechanism 500.

A version of a door retention device 100 have a latching mechanism 515 is shown in FIGS. 5A and 5B. In this version, the latching mechanism 515 is an automatic latching mechanism 520 that automatically latches to secure the door retention device 100 is the downward or door retention position when moved into that position from the upward position. The automatic latching mechanism 520 is sufficiently strong to prevent the biasing mechanism 500 from moving the door retaining member 105 upwardly until the automatic latching mechanism 515 is unlatched. FIGS. 5A and 5B illustrate one design in which the automatic latching mechanism 520 can be unlatched by a simple hand movement. In this version, the automatic latching mechanism 520 becomes unlatched when downward pressure is applied to the first end 120 of the arm 115 of the door retaining member 105. FIG. 5B shows the door retention device 100 with the door retaining member latched into the door retention position. A user can then apply downward pressure on the first end 120 of the arm 115 to move the arm downward relative to the wall mounting member 110. This movement disengages the latching mechanism 515 and allows the biasing mechanism 500 to move the door retaining member 105 upwards, as shown in FIG. 5C. The door retention device 100 is then in the upright door receiving position and is held there by the biasing mechanism 500 until again lowered back into the door retaining position by a user pressing on the second end 130 of the door retaining member 105. As the door retaining member 105 lowers, the automatic latching mechanism 520 engages and maintains the door retention device 100 in the door retaining position.

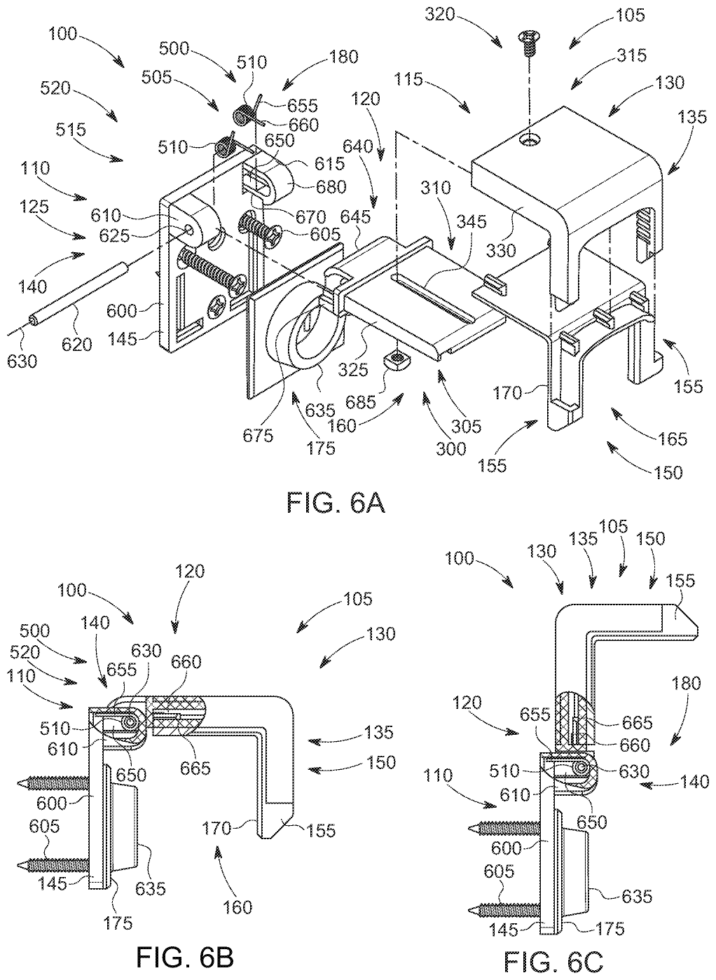

A particular version of the automatic latching mechanism 520 of FIGS. 5A and 5B is shown in more detail in FIGS. 6A through 6C. In this version, the wall mounting member structure 145 of the wall mounting member 110 includes a mounting plate 600 and one or more mounting fasteners 605, such as screws or anchors, that can be driven into an abutment wall to secure the mounting plate 600 and thus the wall mounting member 110 to the abutment wall at a desired location. The wall mounting member 110 also includes the hinge mechanism 140. The hinge mechanism 140 in this version is made up of a first flange 610 and a second flange 615 that each extend from the mounting plate 600 in a direction away from the abutment wall and towards the door retention member 105. The hinge mechanism 140 further includes a hinge bar 620 that extends through a hole 625 in each of the first flange 610 and the second flange 615. The hinge bar 620 creates a hinge axis 630 about which the door retention member 105 can rotate, as shown in FIGS. 6B and 6C. The mounting member pad 175 which in the version of FIG. 6A also includes a padded protrusion 635 for additional door protection can be secured to the mounting plate 600 so s to cover the fasteners 605.

The door retention member 105 is receivable on the hinge mechanism 140 so that it can rotate about the hinge axis 630 from the door retaining position of FIG. 6B to the door receiving position of FIG. 6C. The first end 120 of the arm 115 of the door retaining member 105 includes hinge member 640 that rotates on the hinge bar 620. The hinge member 640 has a body 645 with a hinge hole 650 passing widthwise therethrough. The hinge hole receives the hinge bar 620 when the hinge member 640 is positioned between the first flange 610 and the second flange 615. A torsion spring 510 is positioned to engage both the first flange 610 and the hinge member 640 of the door retaining member 105. In the version of FIG. 6A, two torsion springs 510 may be provided with the second torsion spring 510 engaging the second flange 615 and the hinge member 640. Each torsion spring 510 is positioned within an interior recess 650 within each of the first flange 610 and the second flange 615. Each torsion spring 510 includes a flange leg 655 that contacts the wall of the recess 650 and a hinge member leg 660 that is inserted into a slot 665 in the body 645 of the hinge member 640. The one or more torsion springs 510 are thus able to bias the door retention member 105 towards the door receiving position shown in FIG. 6C.

When moved from the door receiving position shown in FIG. 6C to the door retaining position shown in FIG. 6B, the automatic latching mechanism 520 automatically locks the door retaining member 105 in the door retaining position of FIG. 6B by nature of the interaction of the body 645 of the hinge member 640 and one or both of the first flange 610 and the second flange 615. The first flange 610 and the second flange 615 has a cut out portion 670 that is engageable with a lateral protrusion 675 on the body 645 of the hinge member 640. While moving from the door receiving position of FIG. 6C to the door retaining position of FIG. 6B, the body 645 rotates about the hinge axis 630 and slides along an outer curved surface 680 of the first flange 610 and the second flange 615. Once rotation is complete, the lateral protrusion 675 fits within the cut out portion 670. Because of the action of the torsion spring 510, the lateral protrusion 675 is urged into the cut out portion 670 and a forward wall of the cut out portion 670 prevents upward rotation of the door retention member 105. To disengage the automatic latching mechanism 520, a user can press downwardly on the top surface 685 of the first end 120 of the arm 115. This downward pressure with counteract the urging of the lateral protrusion 675 into the cut out portion 670 and will allow the lateral protrusion 675 to slide out of contact with the forward wall of the cut out portion 670. When this happens, the door retaining member 105 is no longer prevented from rotating upwardly and the one or more torsion springs 510 can then cause the door retaining member 105 to rotate to the door receiving position of FIG. 6C.

Additional optional features are shown in FIG. 6A. For example, the locking mechanism 320 for the length adjusting mechanism 305 can comprise a screw 335 that passes through the opening 340 and the slot 345 and is received in a nut 685. The nut 685 can have a square or otherwise flat outer shape and can be received within a rectangular channel on the underside of the male member 325. The rectangular channel receiving the outer shape of the nut 685 in a manner that prevents rotation of the nut 685 so the screw 335 can be driven therethrough.

The door retention device 100 can be further modified and varied as would be recognized by those skill in the art. For example, the door retaining member 105 can be designed to swing downward relative to the wall mounting member 110 rather than upward. Similarly, the door retaining member 105 can be designed to swing sideways, either horizontally or at a different angle, relative to the wall mounting member 110.

Although the present invention has been described in considerable detail with regard to certain preferred versions thereof, other versions are possible, and alterations, permutations and equivalents of the version shown will become apparent to those skilled in the art upon a reading of the specification and study of the drawings. For example, the cooperating components may be reversed or provided in additional or fewer number. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Therefore, any appended claims should not be limited to the description of the preferred versions contained herein and should include all such alterations, permutations, and equivalents as fall within the true spirit and scope of the present invention.

What is claimed is:

1. A door retention device comprising:
a wall mounting member adapted to be mounted on a wall or other object at a position where the door retention device can engage an open door;
a door retaining member comprising an arm and a door engaging member; and
a connection mechanism rotatably connecting the door retaining member to the wall mounting member,
wherein the door retaining member is rotatable relative to the wall mounting member between a door receiving position where a door can be received without being retained and a door retaining position where the door engaging member can engage the door in a manner that retains the door in an open configuration, and
wherein the connection mechanism includes a mechanism that maintains the door retaining member in the door receiving position and that allows selective movement of the door retaining member to the door retaining position.

2. A door retention device according to claim 1 wherein the connection mechanism comprises a spring that biases the door retaining member towards the door receiving position to maintain the door retaining member in the door receiving position.

3. A door retention device according to claim 2 wherein the connection mechanism comprises a latching mechanism that latches the door retaining member in the door retaining position to prevent the spring from moving the door retaining member to the door receiving position.

4. A door retention device according to claim 2 wherein the connection mechanism comprises a latching mechanism that automatically latches the door retaining member in the door retaining position when the door retaining member is moved from the door receiving position to the door retaining position.

5. A door retention device according to claim 3 wherein the latching mechanism is releasable by pressing downwardly on the arm.

6. A door retention device according to claim 2 wherein the spring is a torsion spring.

7. A door retention device according to claim 1 wherein the connection mechanism comprises one or more magnets to maintain the door retaining member in the door receiving position.

8. A door retention device according to claim 1 wherein the arm is adjustable in length.

9. A door retention device according to claim 1 wherein the arm is adjustable in angular orientation.

10. A door retention device according to claim 1 wherein the door engaging member comprises a hook that is adapted to hook onto a portion of the door.

11. A door retention device according to claim 10 wherein the hook comprises a pair of downward extending prongs that define a doorknob shank receiving space whereby the downward extending prongs can engage the backside of a doorknob by receiving a shank of the doorknob in the doorknob shank receiving space.

12. A door retention device comprising:
a wall mounting member adapted to be mounted on a wall or other object at a position where the door retention device can engage an open door;
a door retaining member comprising an arm and a door engaging member; and
a connection mechanism rotatably connecting the door retaining member to the wall mounting member,
wherein the door retaining member is rotatable relative to the wall mounting member between a door receiving position where a door can be received without being retained and a door retaining position where the door engaging member can engage the door in a manner that retains the door in an open configuration, and
wherein the connection mechanism includes a latching mechanism that latches the door retaining member to maintain it in the door retaining position.

13. A door retention device according to claim 12 wherein the latching mechanism automatically latches the door retaining member in the door retaining position when the door retaining member is moved from the door receiving position to the door retaining position.

14. A door retention device according to claim 13 wherein the door retaining member is biased towards the door receiving position.

15. A door retention device according to claim 13 wherein the latching mechanism is releasable by pressing downwardly on the arm.

16. A door retention device according to claim 12 wherein the arm is adjustable in length or angular orientation.

17. A door retention device according to claim 12 wherein the door engaging member comprises a hook that is adapted to hook onto a portion of the door.

18. A door retention device comprising:
a wall mounting member adapted to be mounted on a wall or other object at a position where the door retention device can engage an open door;
a door retaining member comprising an arm and a door engaging member; and
a connection mechanism rotatably connecting the door retaining member to the wall mounting member,
wherein the door retaining member is rotatable relative to the wall mounting member between a door receiving position where a door can be received without being retained and a door retaining position where the door engaging member can engage the door in a manner that retains the door in an open configuration, and
wherein the arm is adjustable so that the position of the door engaging member relative to the wall mounting member can be adjusted.

19. A door retention device according to claim 18 wherein the arm is adjustable in length.

20. A door retention device according to claim 18 wherein the arm is adjustable in angular orientation.

21. A door retention device comprising:
a wall mounting member adapted to be mounted on a wall or other object at a position where the door retention device can engage an open door;
a door retaining member comprising an arm and a door engaging member; and
a connection mechanism rotatably connecting the door retaining member to the wall mounting member,
wherein the door retaining member is rotatable relative to the wall mounting member between a door receiving position where a door can be received without being retained and a door retaining position where the door engaging member can engage the door in a manner that retains the door in an open configuration, and
wherein the door engaging member comprises a pair of downward extending prongs that define a doorknob shank receiving space whereby the downward extending prongs can engage the backside of a doorknob by receiving a shank of the doorknob in the doorknob shank receiving space.

22. A door retention device according to claim 21 wherein the arm extends substantially in a plane and where in the pair of prongs extend downwardly from the plane of the arm when the door retaining member is in the door retaining position.

23. A door retention device according to claim 21 wherein the connection mechanism includes a spring that biases the door retaining member towards the door receiving position and wherein the connection mechanism comprises a latching mechanism that automatically latches the door retaining member in the door retaining position when moved from the door receiving position to the door retaining position.

24. A method of maintaining a door in an open configuration, the method comprising:
providing a door retention device on a wall the door abuts when open, the door retention device comprising a door retaining member having an arm and a door engaging member;
maintaining the door retaining member is a door receiving position where the door can be opened and closed;
selectively moving the door retaining member out of the door receiving position and into a door retaining position where the door engaging member engages the door in a manner that retains the door in an open configuration;
automatically latching the door retaining member in the door retaining position upon movement from the door receiving position to the door retaining position; and
releasing the latch to return the door retaining member to the door receiving position to allow the door to be closed.

25. A method according to claim 24 wherein door engaging member comprises a pair of downwardly extending prongs that hook around a doorknob of the door.

26. A method according to claim 24 wherein the latch is released by applying downward pressure on the arm.
